(19) United States
(12) Patent Application Publication
(10) Pub. No.: US 2025/0205732 A1
(43) Pub. Date: Jun. 26, 2025

(54) MULTI-NOZZLE PUMP FOR DISPENSING VISCOUS LIQUID

(71) Applicant: PROTEC CO., LTD., Gyeonggi-do (KR)

(72) Inventors: GEUNSIK AHN, Seoul (KR); Keon Hee KIM, Incheon (KR); DAE YONG LEE, Gyeonggi-do (KR); HWAN SEONG PARK, Gyeonggi-do (KR)

(73) Assignee: PROTEC CO., LTD., Gyeonggi-do (KR)

(21) Appl. No.: 18/983,366

(22) Filed: Dec. 17, 2024

(30) Foreign Application Priority Data
Dec. 22, 2023 (KR) 10-2023-0189207

(51) Int. Cl. B05C 11/10; B05B 1/16

(52) U.S. Cl. CPC B05C 11/1013; B05B 1/16; B05C 11/1026

(57) ABSTRACT

Provided is a multi-nozzle pump for dispensing a viscous liquid, and in particular, to a multi-nozzle pump for dispensing a viscous liquid, which dispenses the viscous liquid through a plurality of nozzles with high resolution. The multi-nozzle pump for dispensing the viscous liquid has advantages of miniaturizing intervals between the nozzles and a total size of the pump while simultaneously or individually dispensing the viscous liquid through the plurality of nozzles. Also, according to the multi-nozzle pump for dispensing the viscous liquid, the intervals between the plurality of nozzles may be formed to be narrow as compared with the entire size and the pressing force, and thus, the viscous liquid of high viscosity may be dispensed with high resolution.

### CROSS-REFERENCE TO RELATED APPLICATION

This application is based on and claims priority under 35 U.S.C. § 119 to Korean Patent Application No. 10-2023-0189207, filed on Dec. 22, 2023, in the Korean Intellectual Property Office, the disclosure of which is incorporated by reference herein in its entirety.

### BACKGROUND

### Field

The present disclosure relates to a multi-nozzle pump for dispensing a viscous liquid, and in particular, to a multi-nozzle pump for dispensing a viscous liquid, which is capable of dispensing the viscous liquid through a plurality of nozzles at high resolution.

### Description of the Related Art

A dispenser that supplies a constant amount of liquid such as water, oil, resin, etc. is being used in various fields such as semiconductor processes, medical fields, etc.

Recently, attempts to use a dispenser that dispenses the viscous liquid through nozzles in a process of applying sealant or applying exterior paint in processes of manufacturing vehicles have been made.

In the case of vehicle manufacturing processes, a dispenser having a structure that may easily adjust shapes of figures, line widths (thickness), various patterns, etc. while applying a liquid of a relatively high viscosity onto a larger area is necessary. As described above, in order to perform the application on a large area in a short period of time, a pump having a plurality of nozzles is necessary. Also, in order to dispense the viscous liquid onto an accurate position at high resolution, a dispenser having a structure in which a plurality of nozzles are arranged with narrow intervals and discharging of viscous liquid from each of the nozzles may be individually adjusted is necessary.

Also, in order to apply a large amount of the viscous liquid of high viscosity onto a relatively larger area, a driving pressure of the pump has to be increased, and thus, a size of the pump is increased. However, in order to apply the viscous liquid with high resolution to an internal structure of a vehicle, which is complicated, while moving the pump by using a robot, the driving force of the pump has to be strong while reducing the size of the pump. Also, intervals between the nozzles have to be narrow.

### SUMMARY

The present disclosure provides a multi-nozzle pump for dispensing a viscous liquid, which is small in size and has a structure in which nozzles have narrow intervals therebetween while strongly discharging the viscous liquid of high viscosity through a plurality of nozzles.

The multi-nozzle pump for dispensing a viscous liquid, includes a plurality of pump units each including a pump body, a lever installed to be rotatable with respect to a hinge shaft installed on the pump body, a valve rod connected to the lever so as to ascend/descend according to a rotation of the lever, and a piezoelectric actuator that is installed in the pump body while being in contact with the lever by an end portion so that, when a voltage is applied to the piezoelectric actuator, a length of the piezoelectric actuator increases and the lever is pressed so that the lever rotates about the hinge shaft,
a pump support member to which the plurality of pump units are fixedly coupled to be supported, while the plurality of pump units are arranged so that, as at least some of the plurality of pump units proceed in a direction in which the valve rods are located, an interval with adjacent pump unit is reduced, and a valve body including a plurality of storage portions in which end portions of the valve rods in the plurality of pump units are inserted and a liquid is stored, and a plurality of nozzles formed to be in communication respectively with the plurality of storage portions so that the liquid in the plurality of storage portions is discharged as the plurality of valve rods move back and forth with respect to the plurality of storage portions.

### BRIEF DESCRIPTION OF THE DRAWINGS

FIG. 1 is a perspective view of a multi-nozzle pump for dispensing a viscous liquid according to an embodiment of the present disclosure;

FIG. 2 is an exploded perspective view of the multi-nozzle pump for dispensing the viscous liquid of FIG. 1;

FIG. 3 is a cross-sectional view showing a part of the multi-nozzle pump for dispensing the viscous liquid of FIG. 1;

FIG. 4 is a plan view showing a part of the multi-nozzle pump for dispensing the viscous liquid of FIG. 1;

FIG. 5 is a perspective view showing a part of the multi-nozzle pump for dispensing the viscous liquid of FIG. 1;

FIG. 6 is a cross-sectional view taken along line VI-VI of FIG. 5; and

FIG. 7 is a cross-sectional view showing a part of the multi-nozzle pump for dispensing the viscous liquid of FIG. 1.

### DETAILED DESCRIPTION

Hereinafter, a multi-nozzle pump for dispensing a viscous liquid according to an embodiment of the present disclosure is described below with reference to accompanying drawings.

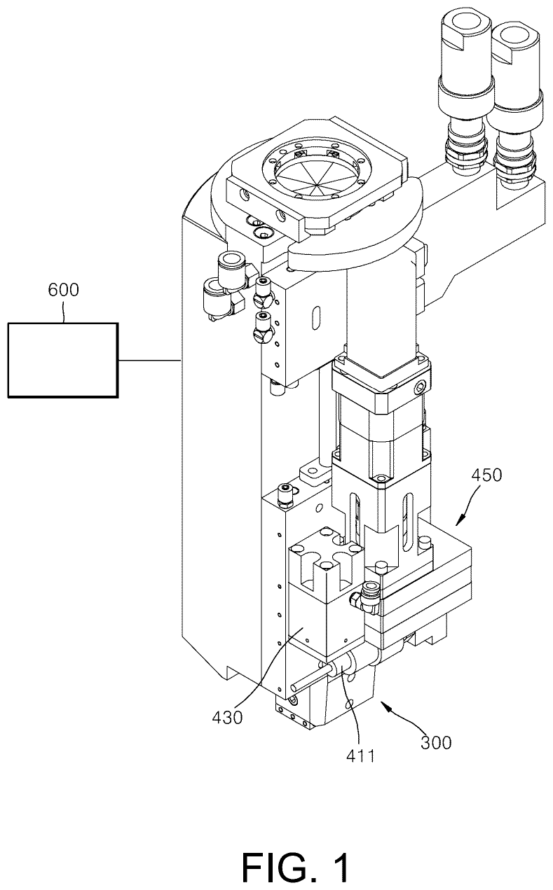

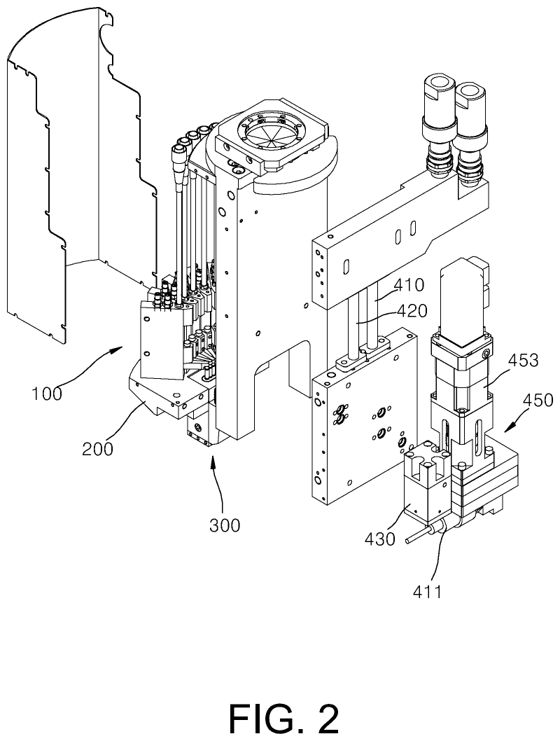

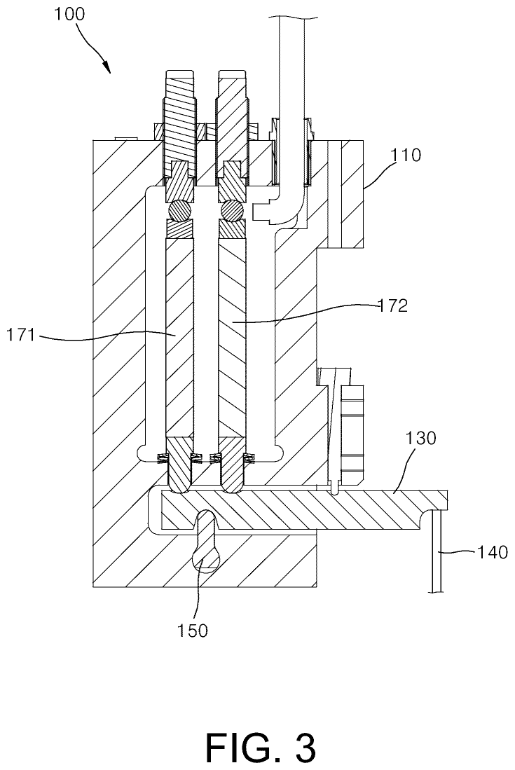

FIG. 1 is a perspective view of a perspective view of a multi-nozzle pump for dispensing a viscous liquid according to an embodiment of the present disclosure, FIG. 2 is an exploded perspective view of the multi-nozzle pump for dispensing the viscous liquid of FIG. 1, and FIG. 3 is a cross-sectional view showing a part of the multi-nozzle pump for dispensing the viscous liquid of FIG. 1.

Referring to FIGS. 1 to 3, a multi-nozzle pump for dispensing a viscous liquid according to the embodiment includes a plurality of pump units 100, a pump support member 200, a valve body 300, and a controller 600.

The plurality of pump units 100 may each include a pump body 110, a lever 130, a valve rod 140, and piezoelectric actuators 171 and 172.

The lever 130 and the piezoelectric actuators 171 and 172 are installed in the pump body 110 and supported. In the embodiment, the pump unit 100 has a pair of piezoelectric actuators 171 and 172 installed in the pump body 110. The piezoelectric actuators 171 and 172 include piezoelectric elements. When a voltage is applied to the piezoelectric elements, lengths of the piezoelectric actuators may be increased or decreased according to a potential of the applied voltage. A hinge shaft 150 is installed in the pump body 110, and the lever 130 is installed to be rotatable relative to the hinge shaft 150. The piezoelectric actuators 171 and 172 are installed on opposite sides based on the hinge shaft 150 so that end portions of the piezoelectric actuators 171 and 172 come into contact with the lever 130. When the voltage is applied and the lengths of the piezoelectric actuators alternately increase, the lever 130 pushed by the piezoelectric actuators rotates relative to the hinge shaft 150. When voltages of opposite polarities are applied to the pair of piezoelectric actuators 171 and 172, the lever 130 performs reciprocating rotation sequentially with respect to the hinge shaft 150. In the embodiment, the piezoelectric actuators 171 and 172 of a multi-stack type, in which the plurality of piezoelectric elements are stacked, are used.

The valve rod 140 extends in a vertical direction and is connected to the end portion of the lever 130. When the lever 130 rotates with respect to the hinge shaft 150, the valve rod 140 ascends and descends with respect to the valve body 300 due to the lever 130.

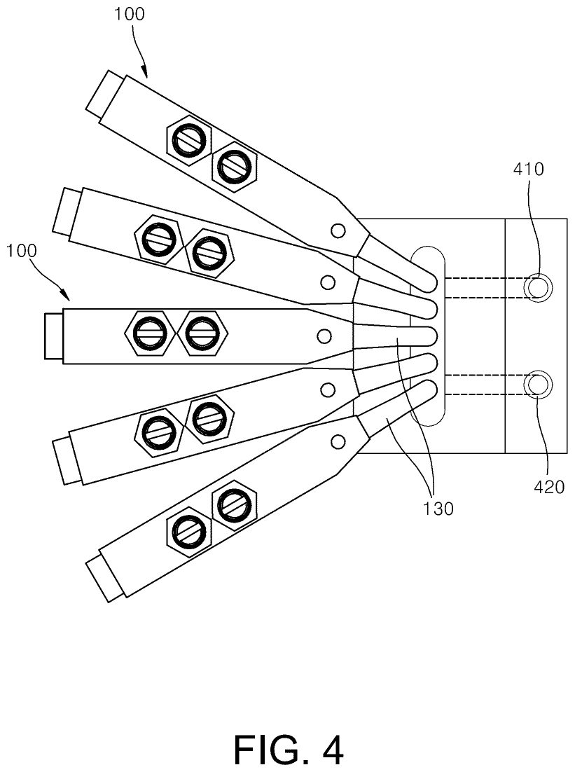

In the embodiment, five pump units 100 configured as described above are provided. The pump units 100 as above are radially arranged at constant angular intervals therebetween as shown in FIG. 4. That is, the pump units 100 are arranged so that the interval with adjacent pump unit 100 is reduced as the lever 130 proceeds toward the valve body 300, and then are coupled to the pump support member 200. The pump support member 200 is configured so that the pump units 100 are coupled and supported while fixing the positions and directions of the pump units 100. By arranging the pump units 100 as above, the intervals between the valve rods 140 may be formed to be narrow.

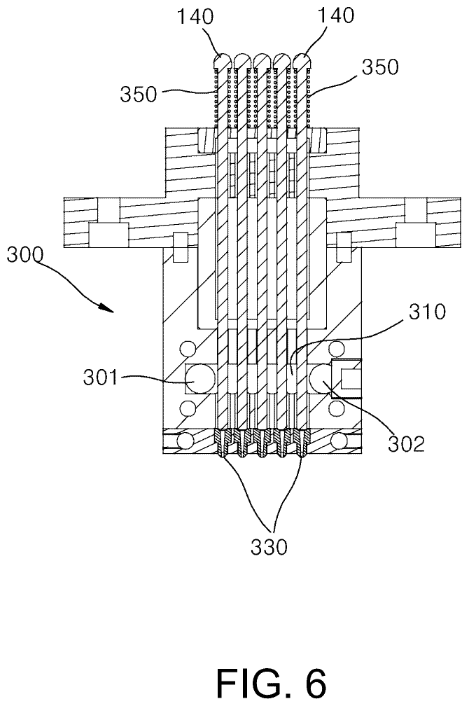

Referring to FIGS. 2 and 6, the valve body 300 includes a plurality of storage portions 310 and a plurality of nozzles 330. The number of storage portions 310 is equal to the number of pump units 100. In the embodiment, the valve body 300 has five storage portions 310. The storage portion 310 stores the viscous liquid. Also, each of the storage portions 310 is formed so that the lower portion of the valve rod 140 of the pump unit 100 is inserted therein. In conjunction with the reciprocating rotation of the lever 130, the valve rod 140 may reciprocate back and forth with respect to the storage portion 310. The plurality of nozzles 330 are formed in the valve body 300 so as to be in communication with respective storage portions 310. The viscous liquid stored in the storage portion 310 may be discharged through the nozzle 330 according to the operation of the valve rod 140. In the embodiment, five nozzles 330 are formed in the valve body 300 so as to be arranged in a straight line at constant intervals.

Referring to FIG. 6, the valve body 300 has five springs 350 installed therein according to the embodiment. The springs 350 are installed to push out the valve rods 140 in a direction away from the nozzles 330, respectively. The spring 350 assists the piezoelectric actuators 171 and 172 to ascend the vale rod 140. The valve rod 140 ascends due to the pressing force of the spring 350 to be away from the nozzle 330, and then respectively opens the nozzle 330.

The storage portions 310 may be formed to be independent from each other or to be in communication with each other. In the embodiment, the storage portions 310 are formed to be in communication with adjacent storage portions 310 as shown in FIG. 6. Also, the valve body 300 has an inlet 301 and an outlet 302. The viscous liquid is supplied to the storage portions 310 via the inlet 301. When the viscous liquid is not discharged through the nozzles 330, the viscous liquid in the storage portions 310 may be returned to a storage tank through the outlet 302 and circulated.

The multi-nozzle pump for dispensing the viscous liquid according to the embodiment may discharge the viscous liquid in two modes according to the structures of the pump units 100 and the valve body 300. When the viscous liquid is discharged in a continuous mode, the valve rods 140 open/close the corresponding nozzles 330, respectively. In the case in which the valve rod 140 is in contact with the nozzle 330, the nozzle 330 is in closed state. When the valve rod 140 is lifted due to the lever 130 and the spring 350, the nozzle 330 is opened and the viscous liquid is discharged through the nozzle 330. In order to discharge the viscous liquid with a sufficient pressure, the viscous liquid is supplied to the inlet 301 with an appropriate pressure. In the case in which the viscous liquid is discharged in a pulse mode, the viscous liquid is discharged through the nozzles 330 by a jetting method. When the valve rod 140 descends toward the nozzle 330 at a high speed and then ascends, a moment of the valve rod 140 is transferred to the viscous liquid and the viscous liquid is discharged through the nozzle 330 in a shape of droplets or similar shape. Here, according to the characteristics of the viscous liquid or the characteristics of liquid dispersion, the valve rod 140 may descend to a position contacting the nozzle 330 or may descend to a position not contacting the nozzle 330 and then ascend. Such above stroke of the valve rod 140 is adjusted by the pump unit 100 operated by the controller 600.

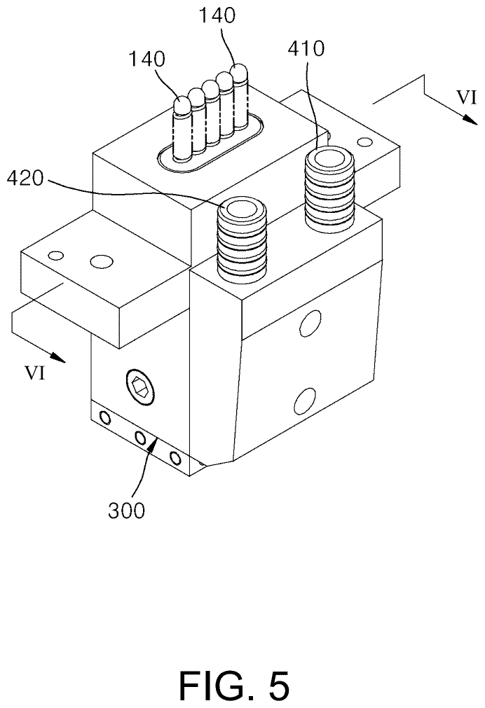

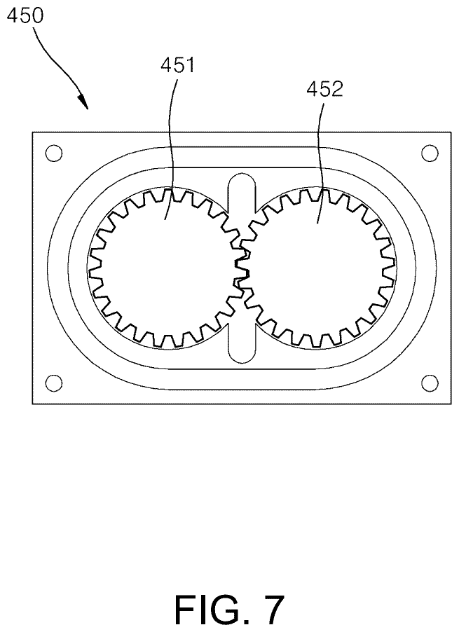

Referring to FIG. 2 and FIG. 5, an inlet flow path 410 is connected to the inlet 301 of the valve body 300. A pressing pump 450 is installed in the inlet flow path 410 so as to press the liquid with a sufficient pressure and supply the liquid to the inlet 301. The pressing pump 450 may include various kinds of pumps. In the embodiment, the pressing pump 450 of a gear pump type is used as shown in FIG. 7. The gear pump may transfer the viscous liquid of high viscosity to the inlet 301 of the valve body 300 with a sufficient pressure. In the embodiment, the pressing pump 450 having the structure as shown in FIGS. 2 and 7 is used. The pressing pump 450 includes a servomotor 453 and a gear box. The controller 600 controls operations of the servomotor 453. A driving gear 451 is rotated by the servomotor 453 and a driven gear 452 engaged with the driving gear 451 is rotated. The viscous liquid is pressed by the rotations of the driving gear 451 and the driven gear 452 installed in the gear box and transferred to the inlet flow path 410.

A pressure sensor 411 is installed in the inlet flow path 410 between the pressing pump 450 and the inlet 301. A measurement value of the pressure sensor 411 is transferred to the controller 600. The controller 600 receives feedback of the measurement value from the pressure sensor 411 and controls the operations of the pressing pump 450 and the pump unit 100. When the controller 600 individually or simultaneously operates the valve rods 140 of the pump units 100, the pressures in the storage portions 310 are changed according to opening of the respective nozzles 330. The pressure sensor 411 measures the variation in the pressure as above, and the controller 600 adjusts the operation of the pressing pump 450 so that the viscous liquid may be supplied with an appropriate pressure according to the purposes of dispensing the viscous liquid. The controller 600 may control the operation of the pressing pump 450 so that a constant pressure set in advance may be maintained in the storage portion 310. The pressure in the storage portion 310 may decrease according to the number of nozzles 330 that are opened by the valve rods 140 and the springs 350, and the controller 600 operates the pressing pump 450 so as to compensate for the decrease in the pressure.

An outlet flow path 420 is connected to the outlet 302 of the valve body 300. The viscous liquid that is not discharged through the nozzle 330 from the storage portion 310 is returned to the storage tank through the outlet flow path 420. An outlet valve 430 is installed on the outlet flow path 420. The controller 600 controls the operation of the outlet valve 430 as well. When all of the nozzles 330 are closed by the valve rods 140, the outlet valve 430 is opened so that the viscous liquid is continuously returned to the storage tank and circulated. As described above, because the viscous liquid is circulated via the outlet valve 430 and the outlet flow path 420, the hardening of the viscous liquid may be prevented. Also, there is the case in which the temperature of the viscous liquid is increased by heating the valve body 300 for dispensing characteristics of the viscous liquid, and in this case, the temperature of the viscous liquid may be prevented from unnecessarily increasing or the viscous liquid may be prevented from hardening by circulating the viscous liquid via the outlet valve 430 and the outlet flow path 420.

Hereinafter, operations of the multi-nozzle pump for dispensing the viscous liquid configured as above according to the embodiment are described below.

First, the controller 600 operates the pressing pump 450 so as to supply the viscous liquid to the inlet 301 of the valve body 300 via the inlet flow path 410. Here, the controller 600 receives feedback of the measurement value from the pressure sensor 411 installed in the inlet flow path 410 and operates the pressing pump 450 so that the viscous liquid may be supplied with a preset pressure.

When the pressing pump 450 of the gear pump type is used, the viscous liquid of high viscosity may be pressed with a sufficient pressure and supplied to the inlet 301. In the embodiment, the viscous liquid is pressed by driving the gear connected to the servomotor 453. The controller 600 controls the pressing pump 450 so that the viscous liquid reaches a target pressure by adjusting an angular displacement and an angular velocity of the servomotor 453.

The viscous liquid supplied through the inlet 301 is supplied to the storage portions 310. Here, the controller 600 operates the piezoelectric actuators 171 and 172 to descend the valve rods 140 and close the corresponding nozzles 330. Also, the controller 600 closes the outlet valve 430, and thus, the viscous liquid is locked in the storage portions 310.

In the above state, the controller 600 ascends and descends the valve rods 140 by operating the piezoelectric actuators 171 and 172. When the piezoelectric actuators 171 and 172 rotate the lever 130 in a direction in which the valve rod 140 ascends, the valve rod 140 ascends with the assist of the pressing force of the spring 350 and opens the nozzle 330 corresponding thereto. When the nozzle 330 is opened, the viscous liquid is discharged through the nozzle 330 due to the pressure of the viscous liquid stored in the storage portion 310.

When the viscous liquid is discharged through the nozzles 330 after installing the multi-nozzle pump for dispensing the viscous liquid according to the embodiment on a separate transport device or a transport robot and moving, the viscous liquid may be variously discharged in shapes of curves, straight lines, and dashed lines. In the multi-nozzle pump for dispensing the viscous liquid according to the embodiment, there are five nozzles 330, and thus, when the viscous liquid is discharged while vertically moving each valve rod 140 by the controller 600, the viscous liquid may be dispensed with respect to a target material while drawing various patterns similarly to a printing method.

Also, as described above, because the viscous liquid is pressed with high pressure by using the pressing pump 450 of the gear pump type and is discharged through the nozzles 330, the multi-nozzle pump for dispensing the viscous liquid according to the embodiment may precisely and finely disperse the viscous liquid of high viscosity, and may accurately disperse the viscous liquid to a target product that is at a relatively far distance.

Also, as described above, because the five pump units 100 are arranged at constant angular intervals, the interval between the nozzles 330 may be set to be less than the interval between the pump units 100 even when the pump unit 100 is relatively large in volume. Therefore, the nozzles 330 of the valve body 300 are arranged densely so that the interval between the plurality of nozzles 330 is reduced, and thus, the viscous liquid may be precisely and accurately dispensed in various patterns of relatively high resolution.

The valve body 300 of the embodiment is formed so that the five storage portions 310 are in communication with one another as described above. Therefore, the viscous liquid may be supplied simultaneously to the respective storage portions 310 through one inlet 301. According to the above configuration, the valve body 300 may be miniaturized.

In addition, a degree of lowering the pressure in the storage portions 310 may vary depending on the number of the nozzles 330 that are opened when the controller 600 simultaneously or individually ascends and descends the valve rods 140. Here, the controller 600 may receive the measurement value from the pressure sensor 411 installed in the inlet flow path 410 and operates the pressing pump 450 so as to compensate for the decreased pressure. According to the above method, the controller 600 may constantly maintain the discharging characteristics of the viscous liquid discharged through the respective nozzles 330.

As necessary, the controller 600 may operate the pressing pump 450 so as to increase or decrease the pressure of the viscous liquid in advance for a predetermined period of time, prior to the generation of operation signals for opening the nozzles 330 by means of the respective valve rods 140. The controller 600 may calculate the decrease in the pressure in consideration of the number of nozzles 330 that are opened by ascending the valve rods 140 and operate the pressing pump 450 so as to compensate for the calculated value. Also, in consideration of a difference between the time taken to increase/decrease the pressure in the storage portions 310 due to the operation of the pressing pump 450 and the time taken for the valve rods 140 to ascend/descend due to the piezoelectric actuators 171 and 172, the controller 600 may operate the pressing pump 450 in advance regardless of the measurement value of the pressure sensor 411.

When the valve body 300 does not dispense the viscous liquid, all of the valve rods 140 are descended and all of the nozzles 330 are in closed states. In this case, the controller 600 opens the outlet valve 430 so that the viscous liquid supplied to the storage portions 310 due to the pressing pump 450 is returned to the storage tank. When the outlet valve 430 is opened, the viscous liquid continuously returns to the storage tank and circulates. As described above, by circulating the viscous liquid, the viscous liquid may be prevented from hardening and sticking to the periphery of the nozzles 330 or the storage portions 310. Also, when the valve body 300 is heated, unnecessary increase in the temperature of the viscous liquid may be prevented by circulating the viscous liquid.

In addition, as described above, the method in which the viscous liquid is discharged when the valve rod 140 ascends and opens the nozzle 330 is referred to as a discharging method according to the continuous mode. Unlike the continuous mode, the viscous liquid may be discharged in the pulse mode (jetting method). In this case, the controller 600 may allow the viscous liquid to be supplied by the pressing pump 450 with a relatively low pressure. In this case, the viscous liquid is not discharged through the nozzle 330 even when the valve rod 140 ascends. In the case of the jetting method, when the valve rod 140 rapidly descends due to the piezoelectric actuators 171 and 172, the viscous liquid around the lower end portion of the valve rod 140 is discharged through the nozzle 330 due to the moment of the valve rod 140.

The multi-nozzle pump for dispensing the viscous liquid according to the embodiment may be used selectively in one of the continuous mode and the pulse mode according to the characteristics of the viscous liquid including the viscosity of the viscous liquid, the purpose of discharging the viscous liquid, or characteristics of the target product.

The examples of the disclosure are described above, but the scope of the disclosure is not limited thereto.

For example, the pump unit 100 is described above to include two piezoelectric actuators 171 and 172, but the number and the arrangement structure of the piezoelectric actuators may be variously modified. An example in which the spring 350 is used to ascend the valve rod 140 is described above, but the pump unit having a structure of using only the piezoelectric actuators without using the spring 350 may be configured. Also, the spring may be installed and used to apply the pressing force in a direction in which the valve rod descends, not the direction in which the valve rod ascends. Also, the multi-nozzle pump for dispensing the viscous liquid according to the embodiment may be configured so that the behavior of the valve rod is adjusted by the controller, by installing a displacement sensor in the piezoelectric actuator, the lever, or the valve rod.

Also, in the above description, five pump units 100 are arranged at the constant angular intervals and installed in the pump support member 200, but the number of pump units and the arrangement relationship between the pump units may be variously modified as necessary. The interval and the positional relationship between the plurality of nozzles in the valve body may be variously modified as necessary.

Also, the valve body 300 is described so that the plurality of storage portions 310 are in communication with one another in the above description, but the storage portions may be separately formed without communicating with one another.

Also, the structure of the pressing pump 450 installed in the inlet flow path 410 may be variously modified into other various types of pumps, rather than the gear pump type described above. In some cases, the multi-nozzle pump for dispensing the viscous liquid, which has a structure without having the pressing pump, may be implemented. The multi-nozzle pump for dispensing the viscous liquid, in which the pressure sensor is not installed in the inlet flow path, may be implemented.

Also, the multi-nozzle pump for dispensing the viscous liquid according to the previous embodiment described above may be used in both the continuous mode and the pulse mode, but in some cases, the multi-nozzle pump for dispensing the viscous liquid may be implemented to be operated in only one of the continuous mode and the pulse mode.

The multi-nozzle pump for dispensing the viscous liquid according to the disclosure has advantages of miniaturizing the interval between the nozzles and the total size of the pump while simultaneously or individually dispensing the viscous liquid through the plurality of nozzles.

Also, according to the multi-nozzle pump for dispensing the viscous liquid of the disclosure, the interval between the plurality of nozzles may be formed to be narrow as compared with the entire size and the pressing force, and thus, the viscous liquid of high viscosity may be dispensed with high resolution.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope as defined by the following claims.

What is claimed is:

1. A multi-nozzle pump for dispensing a viscous liquid, the multi-nozzle pump comprising:
a plurality of pump units each including a pump body, a lever installed to be rotatable with respect to a hinge shaft installed on the pump body, a valve rod connected to the lever so as to ascend/descend according to a rotation of the lever, and a piezoelectric actuator that is installed in the pump body while being in contact with the lever by an end portion so that, when a voltage is applied to the piezoelectric actuator, a length of the piezoelectric actuator increases and the lever is pressed so that the lever rotates about the hinge shaft;
a pump support member to which the plurality of pump units are fixedly coupled to be supported, while the plurality of pump units are arranged so that, as at least some of the plurality of pump units proceed in a direction in which the valve rods are located, an interval thereof with an adjacent pump unit is reduced; and
a valve body including a plurality of storage portions in which end portions of the valve rods in the plurality of pump units are inserted and a liquid is stored, and a plurality of nozzles formed to be in communication respectively with the plurality of storage portions so that the liquid in the plurality of storage portions is discharged as the plurality of valve rods move back and forth with respect to the plurality of storage portions.

2. The multi-nozzle pump of claim 1, wherein
the plurality of pump units are arranged at constant angular intervals.

3. The multi-nozzle pump of claim 1, wherein
the plurality of pump units are arranged so that intervals between the pump units are reduced toward the valve body, and are coupled to the pump support member.

4. The multi-nozzle pump of claim 3, wherein
the valve body has the plurality of nozzles arranged in a straight line at constant intervals.

5. The multi-nozzle pump of claim 1, wherein
the valve body is formed so that the plurality of storage portions are in communication with one another.

6. The multi-nozzle pump of claim 1, wherein
the valve body further includes an inlet formed to supply the liquid to the plurality of storage portions and an outlet for discharging the liquid from the plurality of storage portions.

7. The multi-nozzle pump of claim 6, further comprising:
an inlet flow path connected to the inlet of the valve body; and
a pressing pump installed in the inlet flow path so as to press the liquid and supply the liquid to the inlet.

8. The multi-nozzle pump of claim 7, further comprising
a controller controlling operations of the plurality of pump units and the pressing pump.

9. The multi-nozzle pump of claim 8, further comprising
a pressure sensor installed in the inlet flow path connecting the pressing pump to the valve body so as to measure a pressure of the liquid,
wherein the controller receives a measurement value from the pressure sensor and controls the operation of the pressing pump.

10. The multi-nozzle pump of claim 9, wherein
the valve body discharges the liquid when the plurality of nozzles are individually opened/closed according to advance/retraction of the plurality of valve rods, and
the controller operates the pressing pump so as to compensate for pressures in the plurality of storage portions according to individual opening/closing of the plurality of nozzles due to individual operations of the plurality of valve rods.

11. The multi-nozzle pump of claim 8, wherein
the pressing pump is provided as a gear pump.

12. The multi-nozzle pump of claim 6, wherein
the plurality of pump units operate to discharge the liquid through the plurality of nozzles in a jetting type as the plurality of valve rods advance/retract with respect to the plurality of storage portions.

13. The multi-nozzle pump of claim 9, further comprising:
an outlet flow path connected to the outlet of the valve body and returning the liquid to a storage tank from the plurality of storage portions; and
an outlet valve installed in the outlet flow path,
wherein the controller controls operation of the outlet valve.
